(19) United States
(12) Patent Application Publication
(10) Pub. No.: US 2017/0019966 A1
(43) Pub. Date: Jan. 19, 2017

(54) DIMMING DEVICE

(71) Applicant: Panasonic Intellectual Property Management Co., Ltd., Osaka (JP)

(72) Inventors: Yoshifumi SUEHIRO, Osaka (JP); Masanori HAYASHI, Osaka (JP); Kiyoshi GOTO, Hyogo (JP)

(21) Appl. No.: 15/124,655

(22) PCT Filed: Mar. 5, 2015
(86) PCT No.: PCT/JP2015/001185

§ 371 Date: Sep. 8, 2016

(30) Foreign Application Priority Data
Mar. 11, 2014 (JP) 2014-047995

(51) Int. Cl. H05B 33/08; H05B 39/04

(52) U.S. Cl. CPC H05B 33/0815; H05B 33/0845; H05B 39/041

(57) ABSTRACT

A determiner determines whether an illumination load is an LED illumination device or an incandescent lamp, based on a voltage of a rectifier within a time period from start of supply of the AC voltage to the rectifier to a time a predetermined time elapses. A control circuit controls a driver under a condition where values of a conduction angle of a switch corresponding to magnitudes of the first DC voltages except a maximum and a minimum thereof in a case where the determiner determines that the illumination load is the LED illumination device are smaller than values of the conduction angles of the switch of a case where the determiner determines that the illumination load is the incandescent lamp.

### TECHNICAL FIELD

The present invention relates to a dimming device configured to adjust a light output of an illumination load.

### BACKGROUND ART

In the past, there has been known an illumination system including an illumination device (illumination load) and a dimming device for adjusting a light output of the illumination load (for example, see JP 2010-80238 A, hereinafter referred to as “Document 1”).

The dimming device in the illumination system described in Document 1 includes a field effect transistor (FET) and a dimming level setter for setting an ON-period of the FET. The dimming device further includes a zero-cross detector for detecting a zero-cross of an AC voltage of an AC power source, a current detector for detecting an output current to the illumination load, and a controller for controlling the FET. The controller includes a waveform measuring part for measuring a waveform of the output current detected by the current detector.

The illumination load includes a light source such as a light emitting diode (LED). Document 1 discloses, as examples of the illumination load, an illumination load including a smoother (hereinafter, referred to as a “first illumination load”) and an illumination load not including a smoother (hereinafter, referred to as a “second illumination load”).

The first illumination load includes: a rectifier circuit including a full-wave rectification diode; a choke coil for blocking high frequency components; the smoother; and the LED, for example. The smoother includes a capacitor and a DC-DC conversion part. The capacitor is connected between output ends of the rectifier circuit via the choke coil to smooth an output voltage of the rectifier circuit. The DC-DC conversion part is connected between both ends of the capacitor to convert a voltage across the capacitor into a predetermined DC voltage. The LED is connected between output ends of the DC-DC conversion part. A series circuit of the dimming device and the AC power source is to be connected between input ends of a diode bridge.

The second illumination load includes a diode bridge and the LED, for example. The LED is connected between output ends of the diode bridge. A series circuit of the dimming device and the AC power source is to be connected between input ends of the diode bridge.

The dimming device of Document 1 is configured to provide phase control based on the AC voltage of the AC power source and to thereby adjust a light output of the illumination load. Specifically, the dimming device is configured to adjust the light output of the illumination load by controlling a period (conduction angle of the FET) during which the FET is on in a half cycle of the AC voltage of the AC power source.

The dimming device is configured to determine whether the illumination load is the first illumination load or the second illumination load, by determining symmetry or asymmetry of the waveform measured by the waveform measuring part.

In a case where the dimming device described above adjusts the light output of the first illumination load in accordance with reverse phase control based on the AC voltage of the AC power source, the FET is turned from an OFF state to an ON state when an absolute value of the AC voltage is zero (approximately zero), and the FET is turned from the ON state to the OFF state when the absolute value of the AC voltage is greater than zero. Therefore, in the dimming device, there is a possibility that some electric charges may still remain in the capacitor in the first illumination load even after the FET is turned from the ON state to the OFF state, and the electric charges remaining in the capacitor may be supplied to the LED. As a result, in the dimming device, a light output of the first illumination device may be greater than a desired light output. Therefore, it is difficult to control the first illumination load to show similar change in light output to the incandescent lamp.

### SUMMARY OF INVENTION

An objective of the present invention is to propose a dimming device capable of controlling an LED illumination device including a capacitor to show a similar change in light output to an incandescent lamp.

A dimming device according to an aspect of the present invention includes a pair of terminals, a switch, a driver, a control circuit, a rectifier, a power supply, and a setter. The switch is connected between the pair of terminals. The driver is configured to turn on and off the switch. The control circuit is configured to control the driver. The rectifier is connected between the pair of terminals in parallel to the switch and is configured to perform full-wave rectification on an AC voltage. The power supply is configured to generate a predetermined DC voltage from a voltage obtained by full-wave rectification on the AC voltage by the rectifier to supply the predetermined DC voltage to the driver and the control circuit. The setter is configured to set a first DC voltage that corresponds to a conduction angle of the switch. The control circuit is configured to control the driver to provide reverse phase control based on the AC voltage and to control the driver in accordance with a magnitude of the first DC voltage set by the setter to thereby change (adjust) a value of the conduction angle of the switch. The control circuit includes a determiner. The determiner is configured to, when a series circuit of an illumination load and an AC power source for supplying the AC voltage is connected between the pair of terminals, determine whether the illumination load is an LED illumination device including a capacitor or an incandescent lamp. The determiner is configured to determine whether the illumination load is the LED illumination device or the incandescent lamp, based on a second DC voltage within a predetermined time period from start of supply of the AC voltage to the rectifier. The second DC voltage corresponds to the voltage obtained by full-wave rectification on the AC voltage by the rectifier. The control circuit is configured to control the driver under a condition where values of the conduction angle of the switch corresponding to magnitudes of the first DC voltages except a maximum and a minimum thereof in a case where the determiner determines that the illumination load is the LED illumination device are smaller than values of the conduction angles of the switch of a case where the determiner determines that the illumination load is the incandescent lamp.

### BRIEF DESCRIPTION OF DRAWINGS

The figures depict one or more implementations in accordance with the present teaching, by way of example only, not by way of limitations. In the figures, like reference numerals refer to the same or similar elements.

FIG. 1 is a circuit diagram of a dimming device according to the present embodiment.

FIG. 2 is a schematic diagram of a control circuit, a power supply, and a setter in the dimming device according to the present embodiment.

FIG. 3 is a front view of the dimming device according to the present embodiment.

FIG. 4 is a graph illustrating a voltage waveform of an input voltage of a rectifier and a voltage waveform of a second DC voltage in the dimming device according to the present embodiment in a case where an illumination load is an incandescent lamp.

FIG. 5 is a graph illustrating a voltage waveform of an input voltage of a rectifier and a voltage waveform of a second DC voltage in the dimming device according to the present embodiment in a case where the illumination load is an LED illumination device.

FIG. 6 is a graph illustrating a relationship between a first DC voltage and a conduction angle of a switch in a dimming device of comparative example.

FIG. 7 is a graph illustrating a waveform of a voltage across a switch and a current waveform of a current flowing through the switch in the dimming device of comparative example in a case where an illumination load is an incandescent lamp.

FIG. 8 is a graph illustrating a waveform of a voltage across a switch and a current waveform of a current flowing through the switch in the dimming device of comparative example in a case where the illumination load is an LED illumination device.

FIG. 9 is a graph illustrating a relationship between a first DC voltage and a light output of the illumination load in the dimming device of comparative example.

FIG. 10 is a graph illustrating a relationship between a first DC voltage and a conduction angle of a switch in the dimming device according to the present embodiment.

FIG. 11 is a graph illustrating a waveform of a voltage across a switch and a current waveform of a current flowing through the switch in the dimming device according to the present embodiment in a case where the illumination load is an LED illumination device.

FIG. 12 is a graph illustrating a relationship between a first DC voltage and a light output of the illumination load in the dimming device according to the present embodiment.

FIG. 13 is a graph illustrating an example of an LED illumination device.

### DESCRIPTION OF EMBODIMENTS

Hereinafter, a dimming device 10 according to the present embodiment is described in detail with reference to drawings.

The dimming device 10 is a dimmer, for example. The dimmer is configured to be attached to a flush type wiring device mounting frame.

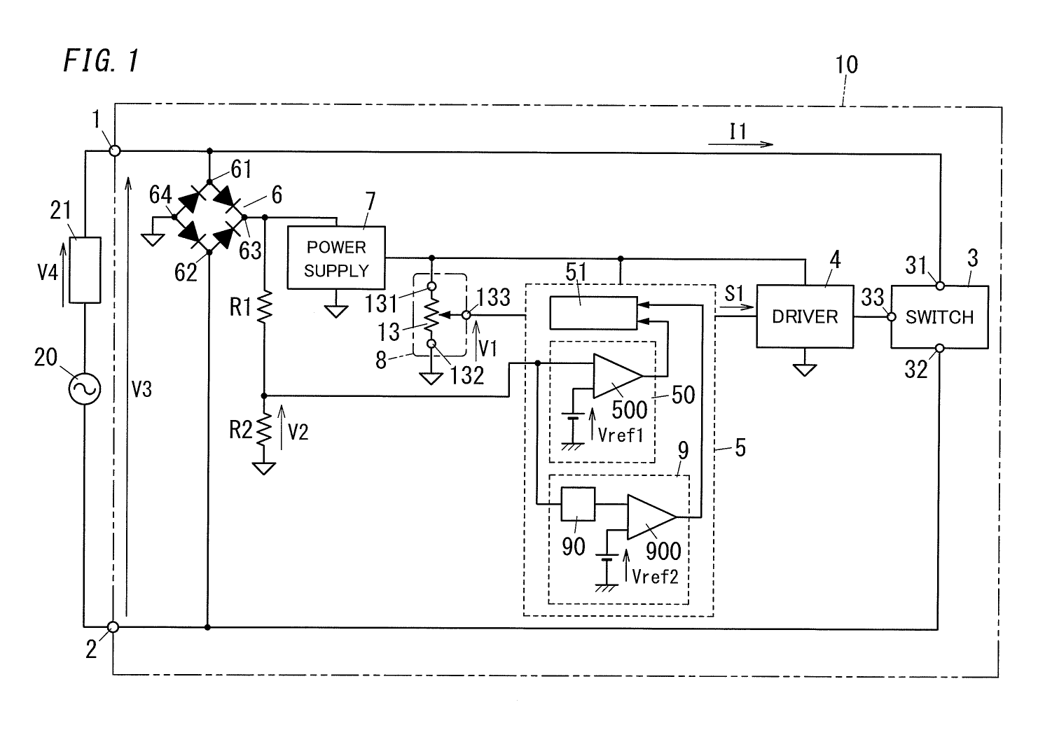

As shown in FIG. 1, the dimming device 10 includes a pair of terminals 1 and 2, a switch 3 connected between the pair of terminals 1 and 2, and a driver 4 configured to turn on and off the switch 3. The dimming device 10 further includes a control circuit 5 configured to control the driver 4, a rectifier 6 configured to perform full-wave rectification on an AC voltage (supplied from an external AC power source 20), and a power supply 7 configured to supply power to the driver 4 and the control circuit 5.

The rectifier 6 is electrically connected between the pair of terminals 1 and 2. A series circuit of the AC power source 20 for outputting an AC voltage and an illumination load 21 is to be electrically connected between the pair of terminals 1 and 2. The AC power source 20 is a commercial power supply, for example. The illumination load 21 is an incandescent lamp or an LED illumination device, for example.

An example of the LED illumination device is an illumination load (LED lamp) 100 shown in FIG. 13. The illumination load 100 is the LED illumination device including a capacitor C1. The AC power source 20 and the illumination load 21 are not included in the dimming device 10 as constituent elements. Hereinafter, for convenience of explanation, one terminal 1 (a terminal to be connected to the illumination load 21 side) of the pair of terminals 1 and 2 of the dimming device 10 is referred to as a first input terminal 1, and the other terminal 2 (a terminal to be connected to the AC power source 20 side) of them is referred to as a second input terminal 2. Hereinafter, for convenience of explanation, the LED illumination device including a capacitor may be simply called an “LED illumination device”.

As shown in FIG. 13, the illumination load 100 includes a pair of terminals 101 and 102, a capacitor C1, a diode bridge 103, a converter 104, a light source 105, a control circuit 106, and a power supply 107. The capacitor C1 is connected between the pair of terminals 101 and 102 to smooth the AC voltage supplied from the AC power source 20. The diode bridge 103 is placed between the pair of terminals 101 and 102 and connected in parallel to the capacitor C1. A pair of input ends of the diode bridge 103 are connected to both ends of the capacitor C1, respectively. The diode bridge 103 is configured to perform full-wave rectification on the AC voltage smoothed by the capacitor C1. The converter 104 is a voltage boost circuit (or a constant current circuit) including a switching device, for example. The converter 104 is connected between output ends of the diode bridge 103. The converter 104 is configured to convert a voltage obtained by full-wave rectification on the AC voltage by the diode bridge 103 into a DC voltage (or a DC current). The light source 105 includes a plurality of LEDs. The light source 105 is connected between output ends of the converter 104 and is configured to be lit by the power supplied from the converter 104. The control circuit 106 is connected to the converter 104 and is configured to control the switching device of the converter 104. The power supply 107 is a three-terminal regulator, for example. The power supply 107 is configured to generate a predetermined DC voltage (power supply voltage) from the voltage obtained by full-wave rectification on the AC voltage by the diode bridge 103, and supply the generated DC voltage to the control circuit 106.

In the illumination load 100, the converter 104, the control circuit 106, and the power supply 107 are optional and the illumination load 100 may not include these components. Also, the capacitor C1 may be connected between the output ends of the diode bridge 103.

Referring back to FIG. 1, the switch 3 is a switching device, for example. The switching device is a metal oxide semiconductor field effect transistor (MOSFET), for example.

The switch 3 includes a first main terminal 31 (in the present embodiment, a drain terminal) electrically connected to the first input terminal 1. The switch 3 includes a second main terminal 32 (in the present embodiment, a source terminal) electrically connected to the second input terminal 2. The switching device included in the dimming device 10 is the MOSFET, but is not limited to this. For example, the switching device may be an insulated gate bipolar transistor (IGBT)

The driver 4 is a control integrated circuit (IC) for controlling turning on and off of the switch 3, for example. The driver 4 is electrically connected to a control terminal 33 (in the present embodiment, a gate terminal) of the switch 3. The driver 4 is electrically connected to the ground of the dimming device 10.

The control circuit 5 includes a microcomputer 51 with a program, for example. The program is stored in a built-in memory of the microcomputer 51, for example. The control circuit 5 is electrically connected to the driver 4. The control circuit 5 is electrically connected to the ground of the dimming device 10. The dimming device 10 includes the microcomputer 51 as the control circuit 5, but is not limited to such configuration. The control circuit 5 may be a combination of discrete parts, for example.

The control circuit 5 is configured to control the driver 4 to provide reverse phase control based on the AC voltage. The reverse phase control means control of switching the switch 3 from an OFF state to an ON state when the AC voltage of the AC power source 20 becomes equal to zero and of switching the switch 3 from the ON state to the OFF state when the AC voltage of the AC power source 20 becomes equal to a desired value other than zero.

The control circuit 5 is configured to detect a timing (zero-cross) at which the AC voltage of the AC power source 20 is zero, based on the voltage obtained by full-wave rectification on the AC voltage by the diode bridge (rectifier 6), for example. In the present embodiment, the control circuit 5 is configured to detect the zero-cross of the AC voltage of the AC power source 20, based on a voltage across a resistor R2 described later. For example, the control circuit 5 is configured to determine that the AC voltage of the AC power source 20 is at the zero-cross, when an absolute value of the voltage across the resistor R2 becomes equal to or less than a predetermined threshold value V_{ref1} (approximately zero). For example, the control circuit 5 includes a zero-cross detector 50 for detecting a timing at which the AC voltage of the AC power source 20 is zero. For example, the zero-cross detector 50 includes a comparator 500 configured to compare the absolute value of the voltage across the resistor R2 and the predetermined threshold value V_{ref1}. An output of the zero-cross detector 50 is supplied to the microcomputer 51 of the control circuit 5. The zero-cross detector 50 may be included in the microcomputer 51. For example, a value of the voltage across the resistor R2 may be inputted to an A/D conversion port of the microcomputer 51 and be compared with a digital value (threshold value V_{ref1}) retained in the microcomputer 51.

The rectifier 6 is a diode bridge, for example. A first input terminal 61 of a pair of input terminals 61 and 62 of the diode bridge is electrically connected to the first input terminal 1. A second input terminal 62 of the pair of input terminals 61 and 62 of the diode bridge is electrically connected to the second input terminal 2. A first output terminal (positive output terminal) 63 of a pair of output terminals 63 and 64 of the diode bridge is electrically connected to the power supply 7. A second output terminal (negative output terminal) 64 of the pair of output terminals 63 and 64 of the diode bridge is electrically connected to the ground of the dimming device 10. With this configuration, the rectifier 6 can perform full-wave rectification on the AC voltage of the AC power source 20.

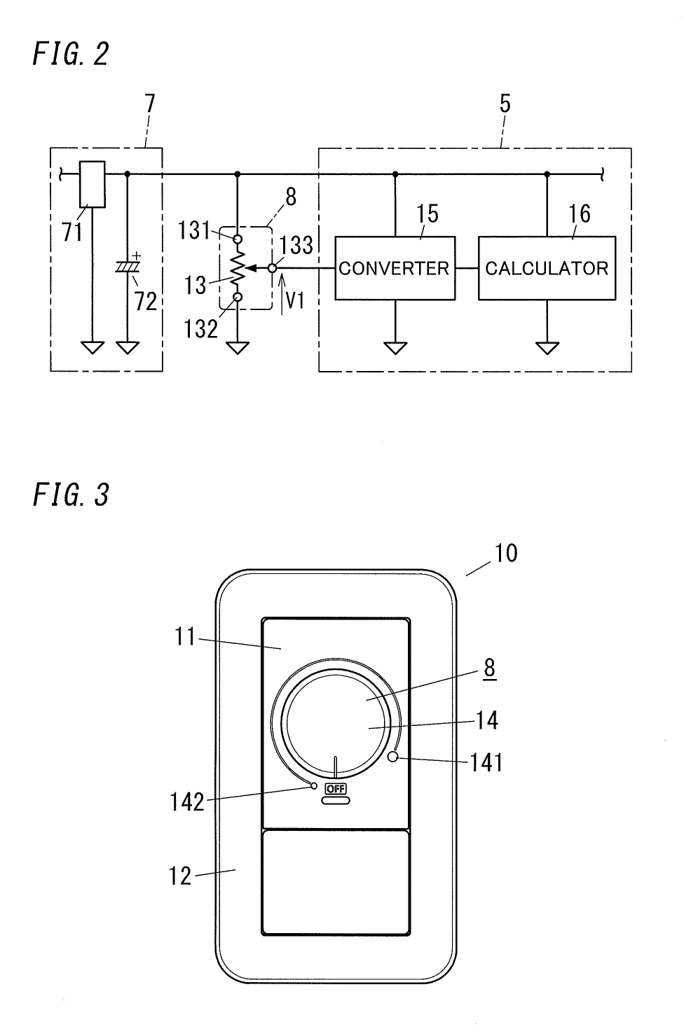

The power supply 7 is configured to generate a predetermined DC voltage from the voltage obtained by full-wave rectification on the AC voltage by the rectifier 6. The power supply 7 is configured to supply this predetermined DC voltage to the driver 4 and the control circuit 5. For example, the power supply 7 includes a three-terminal regulator (constant voltage element) 71, and an electrolytic capacitor 72, as shown in FIG. 2. The three-terminal regulator 71 includes an input terminal electrically connected to the first output terminal 63 of the diode bridge. The three-terminal regulator 71 includes an output terminal electrically connected to a high-voltage side end of the electrolytic capacitor 72. The three-terminal regulator 71 includes a ground terminal electrically connected to the ground of the dimming device 10. The high-voltage side end of the electrolytic capacitor 72 is electrically connected to the driver 4 and the control circuit 5. The electrolytic capacitor 72 includes a low-voltage side end electrically connected to the ground of the dimming device 10. With this configuration, the power supply 7 can generate the predetermined DC voltage from the voltage obtained by full-wave rectification on the AC voltage by the rectifier 6, and supply this predetermined DC voltage to the driver 4 and the control circuit 5. The power supply 7 of the dimming device 10 includes the three-terminal regulator 71, but is not limited to such configuration. The power supply 7 may include a DC-DC converter in place of the three-terminal regulator 71, for example.

The dimming device 10 includes a case 11 (see FIG. 3) and a setter 8. The case 11 accommodates a module substrate on which the switch 3, the driver 4, the control circuit 5, the rectifier 6, and the power supply 7 are provided. The setter 8 is configured to set a first DC voltage V1 that corresponds to a conduction angle of the switch 3. The module substrate indicates a substrate which includes a printed board provided with patterned conductors and on which multiple electronic components constituting the switch 3, the driver 4, the control circuit 5, the rectifier 6, and the power supply 7 are electrically mounted. The conduction angle of the switch 3 corresponds to a period (hereinafter, referred to as an “ON period of the switch 3”) during which the switch 3 is in the ON state.

The case 11 is configured to be attached to the mounting frame. The mounting frame is configured to be attached to a flush box recessed in a wall, for example. The mounting frame is, for example, a mounting frame for interchangeable wiring devices of large square boss type in conformity with Japanese Industrial Standards (JIS). A plate 12 may be attached to the mounting frame so as to cover a front face of the mounting frame.

The setter 8 includes a variable resistor 13, and a manual operation part 14 attached to a rotatable knob of the variable resistor 13.

The variable resistor 13 has a variable resistance value for setting a magnitude of the first DC voltage V1. The variable resistor 13 is a potentiometer including three terminals 131, 132, and 133 (see FIG. 1), for example. The potentiometer serves as a voltage divider. Two terminals (hereinafter, referred to as a first terminal 131 and a second terminal 132) of the potentiometer are connected to both ends of a resistance component, respectively, and a remaining terminal (hereinafter, referred to as a third terminal 133) is connected to a slidable contact that is configured to mechanically slide on the resistance component.

The variable resistor 13 is electrically mounted on the module substrate. The first terminal 131 of the variable resistor 13 is electrically connected to the high-voltage side end of the electrolytic capacitor serving as the power supply 7. The second terminal 132 of the variable resistor 13 is electrically connected to the ground of the dimming device 10. The third terminal 133 of the variable resistor 13 is electrically connected to the control circuit 5. In the dimming device 10, the magnitude of the first DC voltage V1 is determined depending on a resistance value of the variable resistor 13.

The manual operation part 14 is provided so as to be exposed on a front face of the case 11. In the dimming device 10, the resistance value of the variable resistor 13 is changed in accordance with manual operation of the manual operation part 14. In other words, in the dimming device 10, the magnitude of the first DC voltage V1 is set according to manual operation of the manual operation part 14.

In the dimming device 10, the variable resistor 13 is realized by a rotary potentiometer, but is not limited to this. The variable resistor 13 may be a linear potentiometer, for example.

The control circuit 5 is configured to control the driver 4 so as to change a value of the conduction angle of the switch 3 based on the magnitude of the first DC voltage V1 set by the setter 8. As shown in FIG. 2, the control circuit 5 includes a converter 15 and a calculator 16. The converter 15 is configured to convert the magnitude of the first DC voltage V1 (analog value) into a digital value. The calculator 16 is configured to determine a value of the conduction angle of the switch 3 based on the digital value obtained as a result of conversion by the converter 15.

The converter 15 may be a built-in analog to digital converter of the microcomputer 51, for example. The converter 15 is electrically connected to the third terminal 133 of the variable resistor 13.

The calculator 16 may be a built-in calculator of the microcomputer 51, for example. The memory of the microcomputer 51 stores a first data table which associates the digital values to be obtained by the conversion by the converter 15 with values of the conduction angle of the switch 3. The calculator 16 is configured to determine a value of the conduction angle of the switch 3 that is associated with the digital value obtained as a result of the conversion by the converter 15, in accordance with the first data table stored in the memory.

The control circuit 5 is configured to set a different value of the conduction angle depending on whether the illumination load 21 connected to the dimming device 10 is the LED illumination device or the incandescent lamp (described in detail later). Therefore, the first data table includes a first setting table and a second setting table, for example. In the first setting table, digital values to be supplied from the converter 15 (corresponding to respective values of the first DC voltage V1) are exclusively associated with conduction angles of the switch 3 adapted for a case where the illumination load 21 is the LED illumination device. In the second setting table, digital values to be supplied from the converter 15 (corresponding to respective values of the first DC voltage V1) are exclusively associated with conduction angles of the switch 3 adapted for a case where the illumination load 21 is the incandescent lamp. Alternatively, the first data table may include a single data table which associates each of digital values to be supplied from the converter 15 (corresponding to respective values of the first DC voltage V1) with a conduction angle of the switch 3 adapted for a case where the illumination load 21 is the LED illumination device and another conduction angle of the switch 3 adapted for a case where the illumination load 21 is the incandescent lamp, for example.

The control circuit 5 is configured to output, to the driver 4, a control signal S1 for controlling the driver 4. The control signal S1 is a pulse width modulation (PWM) signal, for example. The memory stores a second data table which associates values of the conduction angle of the switch 3 to be determined by the calculator 16 with duty ratios of the control signal S1.

The control circuit 5 is configured to output a control signal S1 containing a duty ratio corresponding to a value of the conduction angle of the switch 3 determined by the calculator 16 in accordance with the second data table stored in the memory. With this configuration, the driver 4 can turn on the switch 3 in accordance with the duty ratio of the control signal S1 outputted from the control circuit 5. Specifically, the control circuit 5 controls the driver 4 such that the switch 3 is turned on with the conduction angle corresponding to the magnitude of the first DC voltage V1 set by the manual operation part 14 (the setter 8). Accordingly, the ON period of the switch 3 can be changed depending on manual operation of the manual operation part 14, and consequently the dimming device 10 can adjust the light output of the illumination load 21. Start time of the ON period of the control signal S1 corresponds to a timing at which the control circuit 5 detects a zero-cross of the AC voltage of the AC power source 20.

As shown in FIG. 1, the control circuit 5 includes a determiner 9 configured to determine whether the illumination load 21 is the LED illumination device or the incandescent lamp. For example, the determiner 9 includes an averaging circuit 90 (including a capacitor, for example) configured to average the voltage across the resistor R2, and a comparator 900 configured to compare an output voltage of the averaging circuit 90 with a predetermined threshold V_{ref2}, as shown in FIG. 1. The determiner 9 may be included in the microcomputer 51. For example, a value of the voltage across the resistor R2 may be inputted to an A/D conversion port of the microcomputer 51 and be compared with a digital value (threshold V_{ref2}) retained in the microcomputer 51.

The determiner 9 is configured to receive a second DC voltage V2 that corresponds to a voltage obtained by full-wave rectification on the AC voltage by the rectifier 6. As shown in FIG. 1, the dimming device 10 includes two resistors R1 and R2. The resistor R1 includes a first end electrically connected to the first output terminal 63 of the diode bridge. The resistor R1 includes a second end electrically connected to a first end of the resistor R2. The first end of the resistor R2 (a connection point of the second end of the resistor R1 and the first end of the resistor R2) is electrically connected to the determiner 9. The resistor R2 includes a second end electrically connected to the ground of the dimming device 10. With this configuration, the determiner 9 is configured to receive a partial voltage (voltage across the resistor R2), which is obtained by dividing the voltage obtained by full-wave rectification on the AC voltage by the rectifier 6, by a series circuit of the resistor R1 and the resistor R2. In other words, the determiner 9 receives the second DC voltage V2 that corresponds to the voltage obtained by full-wave rectification on the AC voltage by the rectifier 6. In short, in the dimming device 10, the voltage across the resistor R2 corresponds to the second DC voltage V2.

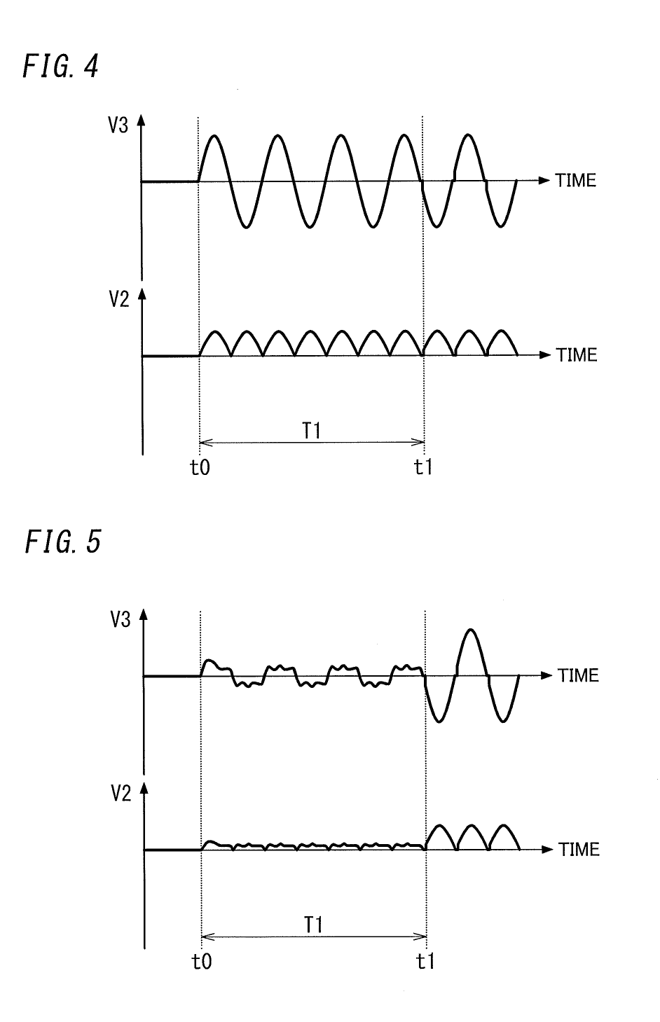

The determiner 9 is configured to determine whether the illumination load 21 is the LED illumination device or the incandescent lamp, based on the second DC voltage V2 within a predetermined time period (determination period) T1 (see FIG. 4 and FIG. 5) from start of supply of the AC voltage to the rectifier 6 (from a start time of supply of the AC voltage to the rectifier 6). Hereinafter, for convenience of explanation, the time period T1 is referred to as a “first period T1”.

The determiner 9 is configured to determine that supply of the AC voltage to the rectifier 6 is started upon the power supply 7 starting supplying power to the control circuit 5 (the determiner 9) or upon the voltage across the resistor R2 reaching a predetermined value, for example.

The control circuit 5 is configured to control the driver 4 such that the switch 3 is kept turned off during the first period T1. The control circuit 5 is configured to, after a lapse of the predetermined time period, control the driver 4 to turn on and off the switch 3.

The determiner 9 is configured to, when an average of the second DC voltage V2 within the first period T1 is equal to or more than the predefined threshold V_{ref2} (determination threshold), determine that the illumination load 21 is the incandescent lamp. Also, the determiner 9 is configured to, when the average is less than the threshold V_{ref2}, determine that the illumination load 21 is the LED illumination device. The threshold V_{ref2} is set to a value that is smaller than an average of the second DC voltage V2 during the first period T1 in a case where the illumination load 21 is the incandescent lamp, and is greater than an average of the second DC voltage V2 during the first period T1 in a case where the illumination load 21 is the LED illumination device. With this configuration, the determiner 9 can determine whether the illumination load 21 is the LED illumination device or the incandescent lamp.

FIG. 4 shows a voltage waveform of an input voltage V3 of the rectifier 6 and a voltage waveform of the second DC voltage V2 in a case where the illumination load 21 is the incandescent lamp. FIG. 5 shows a voltage waveform of the input voltage V3 of the rectifier 6 and a voltage waveform of the second DC voltage V2 in a case where the illumination load 21 is the LED illumination device. A time “t0” in each of FIG. 4 and FIG. 5 indicates a point in time at which the rectifier 6 receives the AC voltage (point in time at which the rectifier 6 starts receiving the AC voltage). A time “t1” in each of FIG. 4 and FIG. 5 indicates a point in time at which the predetermined time period has elapsed.

The control circuit 5 may have a function to determine whether a frequency of the AC power source 20 is 50 Hz or 60 Hz. The control circuit 5 is configured to determine whether the frequency of the AC power source 20 is 50 Hz or 60 Hz based on the second DC voltage V2 within the first period T1. Means for determining whether the frequency of the AC power source 20 is 50 Hz or 60 Hz may be a built-in frequency counter of the microcomputer 51, for example.

The control circuit 5 may be configured to determine whether the frequency of the AC power source 20 is 50 Hz or 60 Hz in parallel with determining whether the illumination load 21 is the LED illumination device or the incandescent lamp. Accordingly, with the dimming device 10, it is possible to reduce a time required for the illumination load 21 to start outputting dimmed light after the rectifier 6 starts receiving the AC voltage, in comparison with a case in which whether the illumination load 21 is the LED illumination device or the incandescent lamp is determined after the frequency of the AC power source 20 is determined to be 50 Hz or 60 Hz. In the control circuit 5 of the present embodiment, a length of the first period T1 is the same as a length of a period (hereinafter, referred to as a “second period”) for determining whether the frequency of the AC power source 20 is 50 Hz or 60 Hz, but such settings are optional. A length of the first period T1 may be shorter than a length of the second period, for example.

The determiner 9 is configured to, when the average (the average of the second DC voltage V2 within the first period T1) is equal to or more than the threshold V_{ref2}, determine that the illumination load 21 is the incandescent lamp, and when the average is less than the threshold V_{ref2}, determine that the illumination load 21 is the LED illumination device, but may not be configured in such a manner. The determiner 9 may be configured to determine whether the illumination load 21 is the LED illumination device or the incandescent lamp, based on a waveform of the second DC voltage V2. Specifically, the determiner 9 may be configured to determine whether the illumination load 21 is the LED illumination device or the incandescent lamp, based on the degree of coincidence obtained as a result of pattern matching between the waveform of the second DC voltage V2 and a preliminarily set reference waveform.

Here, an explanation is given to a supposed dimming device (hereinafter, referred to as a “dimming device of comparative example”) including a control circuit that is different from the control circuit 5. The control circuit of the dimming device of comparative example does not include the determiner 9, for example. The control circuit of the dimming device of comparative example determines a conduction angle in accordance with the first DC voltage V1 without depending on whether the illumination load 21 is the incandescent lamp or the LED illumination device. Elements of the dimming device of comparative example similar to those of the dimming device 10 are assigned the same reference signs as those of the dimming device 10 and explanations thereof will be appropriately omitted. Also, for convenience of explanation, the control circuit 5 of the dimming device 10 may be referred to as a “first control circuit 5”, and the control circuit of the dimming device of comparative example may be referred to as a “second control circuit”.

Further, the following explanation refers to: a case where the incandescent lamp is connected between a pair of terminals 1 and 2 of the dimming device of comparative example as the illumination load 21; and a case where the LED illumination device is connected therebetween as the illumination load 21.

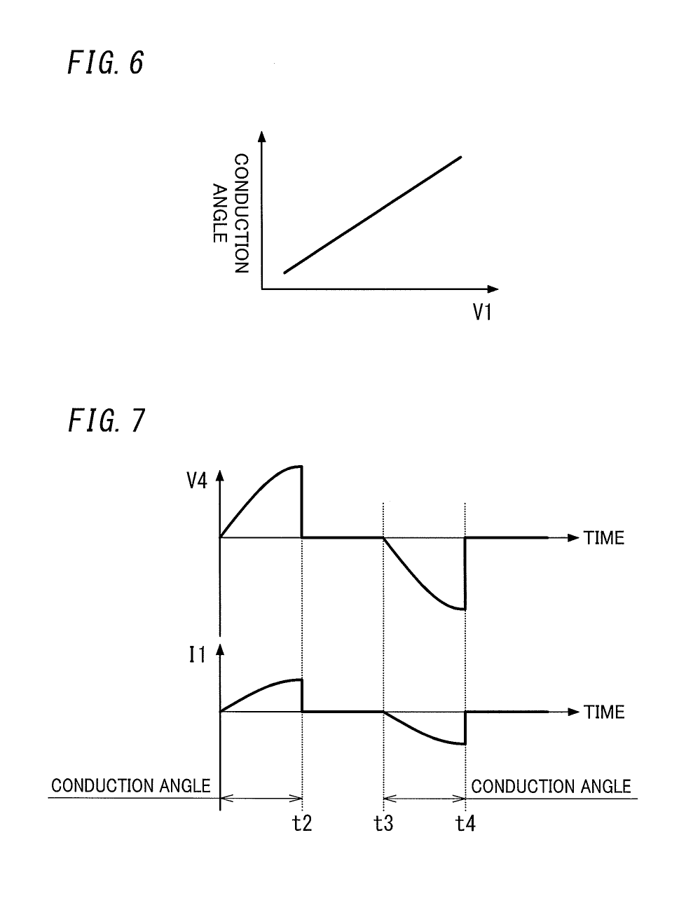

The second control circuit is configured to control the driver 4 so as to increase the conduction angle of the switch 3 at a constant rate with an increase in the first DC voltage V1 as shown in FIG. 6, without depending on whether the illumination load 21 is the incandescent lamp or the LED illumination device. A vertical axis in FIG. 6 represents a value of the conduction angle of the switch 3. A horizontal axis in FIG. 6 represents the magnitude of the first DC voltage V1. A solid straight line in FIG. 6 relates to each of a case where the illumination load 21 is the LED illumination device and a case where the illumination load 21 is the incandescent lamp.

FIG. 7 shows a voltage waveform of a voltage V4 across the illumination load 21 and a current waveform of a current I1 flowing through the switch 3 in a case where the illumination load 21 is the incandescent lamp in the dimming device of comparative example. Times “t2” and “t4” in FIG. 7 each indicate a point in time at which the switch 3 is turned from the ON state to the OFF state. A time “t3” in FIG. 7 indicates a point in time at which the switch 3 is turned from the OFF state to the ON state.

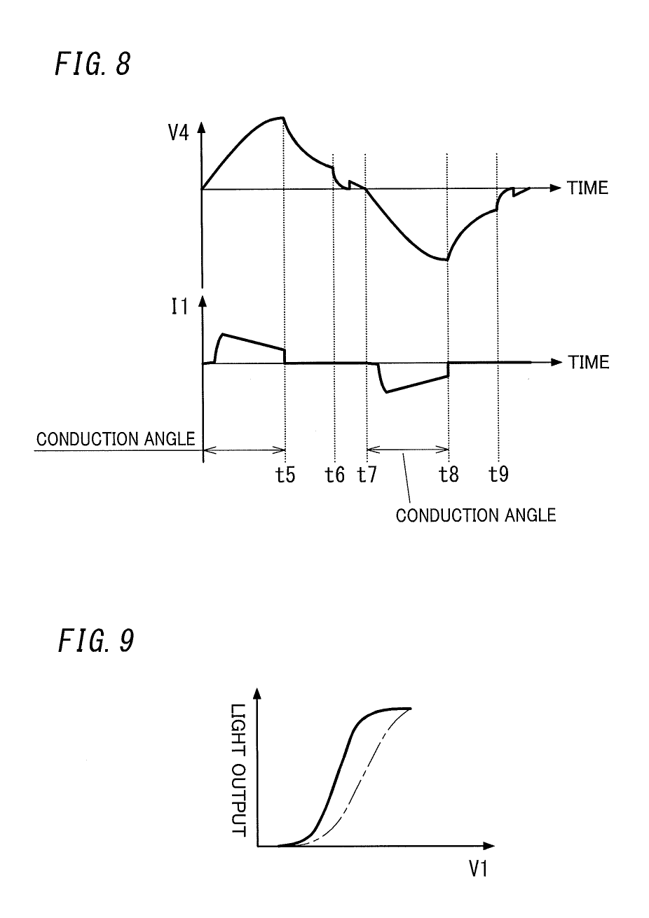

FIG. 8 shows a voltage waveform of the voltage V4 across the illumination load 21 and a current waveform of the current I1 flowing through the switch 3 in a case where the illumination load 21 is the LED illumination device in the dimming device of comparative example. Times “t5” and “t8” in FIG. 8 each indicate a point in time at which the switch 3 is turned from the ON state to the OFF state. Times “t6” and “t9” in FIG. 8 each indicate a point in time at which the electric charge stored in a smoothing capacitor of the LED illumination device is discharged. A time “t7” in FIG. 8 indicates a point in time at which the switch 3 is turned from the OFF state to the ON state. The time “t5” in FIG. 8 indicates the same point in time as the time “t2” in FIG. 7. The time “t7” in FIG. 8 indicates the same point in time as the time “t3” in FIG. 7. The time “t8” in FIG. 8 indicates the same point in time as the time “t4” in FIG. 7.

FIG. 9 shows a relationship between the first DC voltage V1 and the light output of the illumination load 21 of the dimming device of comparative example. A vertical axis of FIG. 9 represents the magnitude of the light output of the illumination load 21. A horizontal axis of FIG. 9 represents the magnitude of the first DC voltage V1. A solid curved line in FIG. 9 relates to a case where the illumination load 21 is the LED illumination device. A dashed-dotted curved line in FIG. 9 relates to a case where the illumination load 21 is the incandescent lamp.

When the illumination load 21 is the LED illumination device in the case of the dimming device of comparative example, there is a possibility that a current still flows through the LEDs in a period (between t5 and t6 in FIG. 8) during which the electric charge stored in the capacitor of the LED illumination device is discharged, even after the MOSFET serving as the switch 3 is turned off. Accordingly, the light output of the LED illumination device as the illumination load 21 lit by the dimming device of comparative example would be greater than the light output of the illumination load 21 of the case where the illumination load 21 is the incandescent lamp, at any of values of the first DC voltage V1 except a maximum and a minimum thereof, as shown in FIG. 9. Therefore, in a case where the illumination load 21 is the LED illumination device in the dimming device of comparative example, the light output of the illumination load 21 may be greater than a desired light output. As a result, in the dimming device of comparative example, in a case where the illumination load 21 is the LED illumination device, it is difficult to control the illumination load 21 to show similar change in light output to the illumination load 21 of a case where the illumination load 21 is the incandescent lamp.

On the other hand, the first control circuit 5 of the dimming device 10 of the present embodiment is configured to control the driver 4 under a condition where values of the conduction angle of the switch 3 corresponding to magnitudes of the first DC voltages V1 except a maximum and a minimum thereof in a case where the determiner 9 determines that the illumination load 21 is the LED illumination device are smaller than values of the conduction angles of the switch of a case where the determiner 9 determines that the illumination load 21 is the incandescent lamp

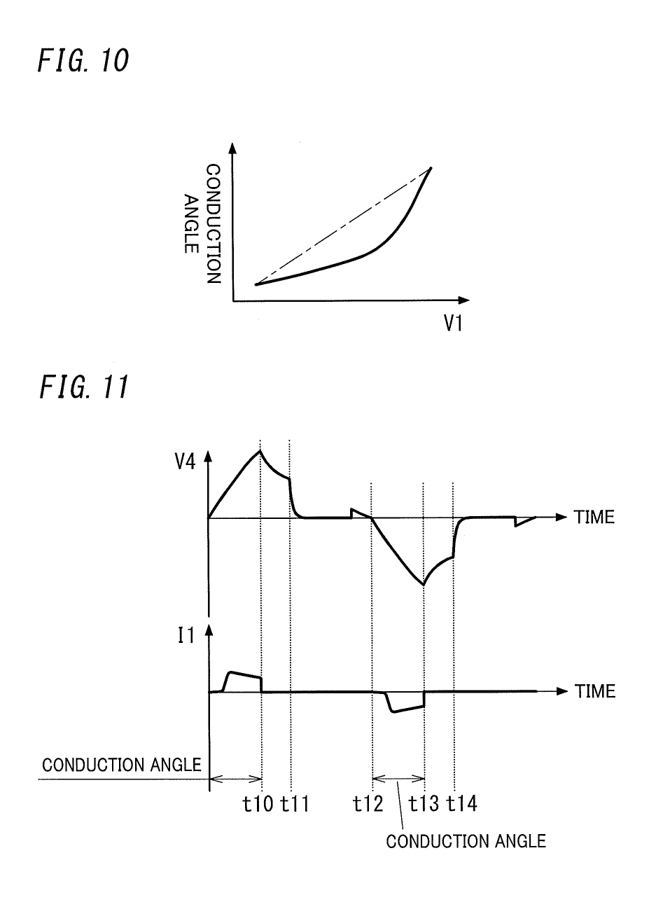

For example, the first control circuit 5 is configured to, in a case where the determiner 9 determines that the illumination load 21 is the incandescent lamp, control the driver 4 so as to increase the conduction angle of the switch 3 at a constant rate with an increase in the first DC voltage V1, as shown in FIG. 10. Also, the first control circuit 5 is configured to, in a case where the determiner 9 determines that the illumination load 21 is the LED illumination device, control the driver 4 so as to increase the conduction angle of the switch 3 at a gradually increasing rate with an increase in the first DC voltage V1. A vertical axis of FIG. 10 represents the value of the conduction angle of the switch 3. A horizontal axis of FIG. 10 represents the magnitude of the first DC voltage. A dashed-dotted straight line in FIG. 10 relates to a case where the determiner 9 determines that the illumination load 21 is the incandescent lamp. A solid curved line in FIG. 10 relates to a case where the determiner 9 determines that the illumination load 21 is the LED illumination device.

FIG. 11 shows a voltage waveform of a voltage V4 across the illumination load 21 and a current waveform of a current I1 flowing through the switch 3 in a case where the illumination load 21 is the LED illumination device with regard to the dimming device 10. Times “t10” and “t13” in FIG. 11 each indicate a point in time at which the switch 3 is turned from the ON state to the OFF state. Times “t11” and “t14” in FIG. 11 each indicate a point in time at which the electric charge stored in a smoothing capacitor of the LED illumination device is discharged. A time “t12” in FIG. 11 indicates a point in time at which the switch 3 is turned from the OFF state to the ON state.

For example, the control circuit 5 is configured to, in a case where the determiner 9 determines that the illumination load 21 is the LED illumination device, select a first ON time for the LED illumination device (corresponding to a conduction angle for the LED illumination device) in accordance with a magnitude of the first DC voltage V1 set by the setter 8. The control circuit 5 turns on the switch 3 when an absolute value of the AC voltage (of the AC power source 20) becomes equal to or smaller than the predetermined threshold value V_{ref1} (approximately 0). Also, in the case where the illumination load 21 is the LED illumination device, the control circuit 5 turns off the switch 3 when the first ON time elapses after the control circuit 5 turns on the switch 3.

For example, the control circuit 5 is configured to, in a case where the determiner 9 determines that the illumination load 21 is the incandescent lamp, select a second ON time for the incandescent lamp (corresponding to a conduction angle for the incandescent lamp) in accordance with the first DC voltage V1 set by the setter 8. The control circuit 5 turns on the switch 3 when the absolute value of the AC voltage (of the AC power source 20) becomes equal to or smaller than the predetermined threshold value V_{ref1} (approximately 0). Also, in the case where the illumination load 21 is the incandescent lamp, the control circuit 5 turns off the switch 3 when the second ON time elapses after the control circuit 5 turns on the switch 3.

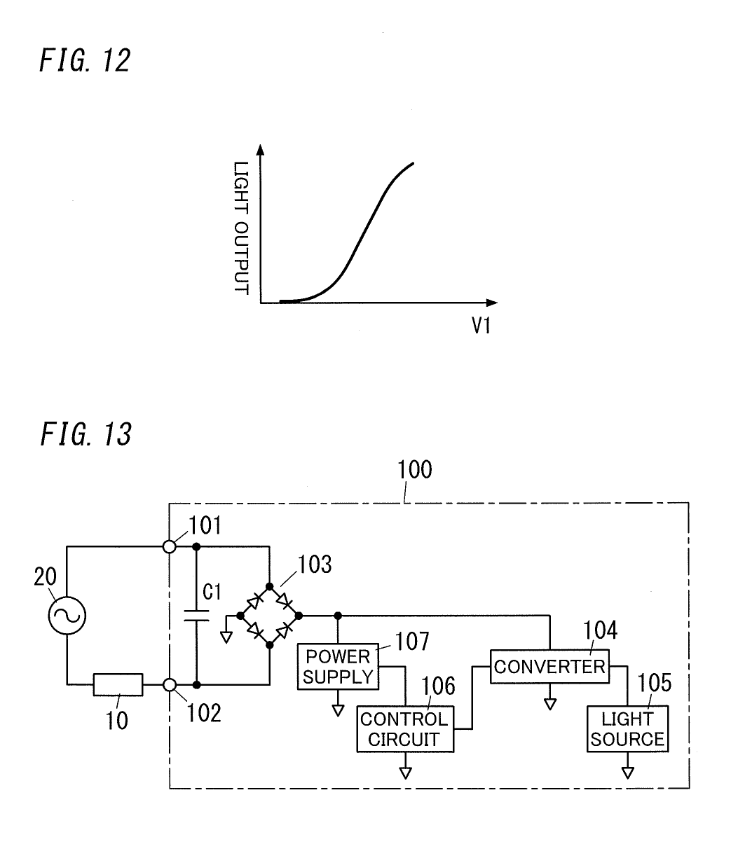

FIG. 12 shows a relationship between the first DC voltage V1 and the light output of the illumination load 21 of the dimming device 10 of the present embodiment. A vertical axis of FIG. 12 represents the magnitude of the light output of the illumination load 21. A horizontal axis of FIG. 12 represents the magnitude of the first DC voltage V1. A solid curved line in FIG. 12 relates to each of a case where the illumination load 21 is the LED illumination device and a case where the illumination load 21 is the incandescent lamp.

With regard to the dimming device 10, in a case where the illumination load 21 is the LED illumination device, the light output of the illumination load 21 changes in response to an increase in the first DC voltage V1 as with the light output of the illumination load 21 in a case where the illumination load 21 is the incandescent lamp, as shown in FIG. 12. Accordingly, in the dimming device 10, in a case where the illumination load 21 is the LED illumination device, it is possible to control the illumination load 21 so as to show a similar change in light output to the illumination load 21 in a case where the illumination load 21 is the incandescent lamp. In brief, when the LED illumination device is connected as the illumination load 21 to the dimming device 10, the dimming device 10 can control the LED illumination device so as to show a similar change in light output to the incandescent lamp.

As described above, the dimming device 10 of the present embodiment includes the pair of terminals 1 and 2, the switch 3, the driver 4, the control circuit 5, the rectifier 6, the power supply 7, and the setter 8. The switch 3 is connected between the pair of terminals 1 and 2. The driver 4 is configured to turn on and off the switch 3. The control circuit 5 is configured to control the driver 4. The rectifier 6 is connected between the pair of terminals 1 and 2 in parallel to the switch 3, and is configured to perform full-wave rectification on an AC voltage. The power supply 7 is configured to generate a predetermined DC voltage from the voltage obtained by full-wave rectification on the AC voltage by the rectifier 6 to supply the predetermined DC voltage to the driver 4 and the control circuit 5. The setter 8 is configured to set a first DC voltage V1 that corresponds to a conduction angle of the switch 3. The control circuit 5 is configured to control the driver 4 to provide reverse phase control based on the AC voltage, and to control the driver 4 in accordance with a magnitude of the first DC voltage V1 set by the setter 8 to thereby change (adjust) a value of the conduction angle of the switch 3. The control circuit 5 includes a determiner 9. The determiner 9 is configured to, when a series circuit of the illumination load 21 and the AC power source 20 for supplying the AC voltage is connected between the pair of terminals 1 and 2, determine whether the illumination load 21 is an LED illumination device including a capacitor or an incandescent lamp. The determiner 9 is configured to determine whether the illumination load 21 is the LED illumination device or the incandescent lamp, based on a second DC voltage V2 within a predetermined time period T1 from start of supply of the AC voltage to the rectifier 6. The second DC voltage corresponds to the voltage obtained by full-wave rectification on the AC voltage by the rectifier 6. The control circuit 5 is configured to control the driver 4 under a condition where values of the conduction angle of the switch 3 corresponding to magnitudes of the first DC voltages V1 except a maximum and a minimum thereof in a case where the determiner 9 determines that the illumination load 21 is the LED illumination device are smaller than values of the conduction angles of the switch 3 of a case where the determiner 9 determines that the illumination load is the incandescent lamp.

In an example, the control circuit 5 is configured to, in a case where the determiner 9 determines that the illumination load 21 is the LED illumination device, determine a first ON time for the LED illumination device in accordance with a value of the first DC voltage V1. Then, (in a case where the determiner 9 determines that the illumination load 21 is the LED illumination device,) the control circuit 5 controls the switch 3 in a manner where the control circuit 5 turns on the switch 3 when an absolute value of the AC voltage becomes equal to or smaller than a predetermined threshold value V_{ref1}, and turns off the switch 3 when the first ON time elapses after the control circuit 5 turns on the switch 3.

Also, the control circuit 5 is configured to, in a case where the determiner 9 determines that the illumination load 21 is the incandescent lamp, determine a second ON time for the incandescent lamp in accordance with a value of the first DC voltage V1. Then, (in a case where the determiner 9 determines that the illumination load 21 is the incandescent lamp,) the control circuit 5 controls the switch 3 in a manner where the control circuit 5 turns on the switch 3 when an absolute value of the AC voltage becomes equal to or smaller than a predetermined threshold value V_{ref1}, and turns off the switch 3 when the second ON time elapses after the control circuit 5 turns on the switch 3.

As described above, in the dimming device 10 of the present embodiment, the control circuit 5 is configured to control the driver 4 under a condition where values of the conduction angle of the switch 3 corresponding to magnitudes of the first DC voltages V1 except a maximum and a minimum thereof in a case where the determiner 9 determines that the illumination load 21 is the LED illumination device are smaller than values of the conduction angles of the switch 3 of a case where the determiner 9 determines that the illumination load 21 is the incandescent lamp. With this configuration, the dimming device 10 can control the LED illumination device including a capacitor so as to show a similar change in light output to the incandescent lamp.

Preferably, the determiner 9 is configured to: when an average of the second DC voltage V2 within the time period T1 is equal to or more than a predefined threshold V_{ref2}, determine that the illumination load 21 is the incandescent lamp; and when the average is less than the threshold V_{ref2}, determine that the illumination load 21 is the LED illumination device.

With this configuration, the determiner 9 can determine whether the illumination load 21 is the LED illumination device including a capacitor or the incandescent lamp more accurately.

Preferably, the determiner 9 is configured to determine whether the illumination load 21 is the LED illumination device or the incandescent lamp based on a waveform of the second DC voltage V2 within the time period T1.

With this configuration, the determiner 9 can determine whether the illumination load 21 is the LED illumination device including a capacitor or the incandescent lamp more accurately.

Preferably, the control circuit 5 is configured to: in a case where the determiner 9 determines that the illumination load 21 is the incandescent lamp, control the driver 4 so as to increase the conduction angle of the switch 3 at a constant rate with an increase in the first DC voltage V1; and in a case where the determiner 9 determines that the illumination load 21 is the LED illumination device, control the driver 4 so as to increase the conduction angle of the switch 3 at a gradually increasing rate with an increase in the first DC voltage V1.

With this configuration, the dimming device 10 can control the LED illumination device including a capacitor so as to show the same change in light output as the incandescent lamp.

In an example, as shown in FIG. 1 and FIG. 2, the rectifier 6 includes the diode bridge. The power supply 7 includes the constant voltage element (three-terminal regulator 71) and the electrolytic capacitor 72. The setter 8 includes the variable resistor 13. The diode bridge includes the pair of input terminals 61 and 62 respectively connected to the pair of terminals 1 and 2 of the dimming device 10. The diode bridge includes the positive output terminal 63 connected to a positive electrode side input terminal of the constant voltage element (the input terminal of the three-terminal regulator 71), and the negative output terminal 64 connected to a negative electrode side input terminal of the constant voltage element (the ground terminal of the three-terminal regulator 71). The constant voltage element includes a positive electrode side output terminal (the output terminal of the three-terminal regulator 71) connected to the positive electrode of the electrolytic capacitor 72, and a negative electrode side output terminal (the ground terminal of the three-terminal regulator 71) connected to the negative electrode of the electrolytic capacitor 72. The variable resistor 13 is connected between the positive electrode and the negative electrode of the electrolytic capacitor 72.

As shown in FIG. 3, the setter 8 includes the manual operation part 14. The manual operation part 14 is attached to the variable resistor 13, and thereby the resistance value of the variable resistor 13 changes in accordance with manual operation of the manual operation part 14. The manual operation part 14 has an operable range between a first end 141 and a second end 142. The setter 8 is configured to determine the first DC voltage V1, in accordance with the output voltage of the power supply 7 and the resistance value of the variable resistor 13 determined depending on a position (rotational position) in the operable range of the manual operation part 14.

In an example, the control circuit 5 includes a data table (first data table) associating the first DC voltages V1 to be set by the setter 8 with the conduction angles for the LED illumination device and the conduction angles for the incandescent lamp. In the first data table, the conduction angles for the incandescent lamp and the conduction angles for the LED illumination device are set such that an LED illumination device brightness ratio is substantially the same as an incandescent lamp brightness ratio as long as the manual operation part 14 is at the same position in the operable range. The LED illumination device brightness ratio indicates a ratio of the brightness of the LED illumination device when the manual operation part 14 at a certain position to maximum LED brightness. The incandescent lamp brightness ratio indicates a ratio of the brightness of the incandescent lamp when the manual operation part 14 at a certain position to maximum lamp brightness. The maximum LED brightness indicates brightness of the LED illumination device when the manual operation part 14 is positioned at the first end 141 in the operable range. The maximum lamp brightness indicates brightness of the incandescent lamp when the manual operation part 14 is positioned at the first end 141 in the operable range.

In other words, in the first data table, the conduction angles for the incandescent lamp and the conduction angles for the LED illumination device are set such that the LED illumination device brightness ratio defined as a ratio of the brightness of the LED illumination device to the maximum LED brightness and the incandescent lamp brightness ratio defined as a ratio of the brightness of the incandescent lamp to the maximum lamp brightness are substantially the same as each other for each value of the first DC voltage V1. The maximum LED brightness corresponds to brightness of the LED illumination device when the first DC voltage V1 has a maximum value. The maximum lamp brightness corresponds to brightness of the incandescent lamp when the first DC voltage V1 has the maximum value. That is, in the first data table, the conduction angles for the incandescent lamp and the conduction angles for the LED illumination device are set such that the LED illumination device and the incandescent lamp show similar changes in brightness depending on a change in the position of the manual operation part 14.

In a specific example, the first data table includes the first setting table associating the first DC voltages V1 to be set by the setter 8 with the conduction angles for the LED illumination device, and the second setting table associating the first DC voltages V1 with the conduction angles for the incandescent lamp.

In other words, the control circuit 5 includes the first setting table and the second setting table. The first setting table is to be used for determining an ON time of the switch 3 in accordance with the first DC voltage V1 when the determiner 9 determines that the illumination load 21 is the LED illumination device. The second setting table is to be used for determining an ON time of the switch 3 in accordance with the first DC voltage V1 when the determiner 9 determines that the illumination load 21 is the incandescent lamp.

Examples of the first setting table and the second setting table are shown in Table 1 (first setting table) and Table 2 (second setting table).

TABLE 1

| position of | | conduction | |
|---|---|---|---|
| manual | | angle (for LED | bright- |
| operation | first DC | illumination | ness |
| part 14 | voltage V1 | device) | ratio |
| first end (P1) | V11 | D11 | B1 |
| P2 | V12 | D12 | B2 |
| P3 | V13 | D13 | B3 |
| . . . | . . . | . . . | . . . |
| second end (PN) | V1N | D1N | BN |

TABLE 2

| position of | | conduction | |
|---|---|---|---|
| manual | | angle (for | bright- |
| operation | first DC | incandescent | ness |
| part 14 | voltage V1 | lamp) | ratio |
| first end (P1) | V11 | D21 | B1 |
| P2 | V12 | D22 | B2 |
| P3 | V13 | D23 | B3 |
| . . . | . . . | . . . | . . . |
| second end (PN) | V1N | D2N | BN |

In Table 1, P1 to PN indicate positions of the manual operation part 14 that are distributed at equal intervals within the operable range (a range between the first end 141 and the second end 142). V11 to V1N indicate values of the first DC voltage V1 when the manual operation part 14 is at the positions P1 to PN, respectively adapted for a case where the illumination load 21 is the LED illumination device. D11 to D1N indicate conduction angles of the switch 3 when the manual operation part 14 is at the positions P1 to PN (corresponding to the values V11 to V1N of the first DC voltage V1), respectively adapted for a case where the illumination load 21 is the LED illumination device. B1 to BN indicate ratios of the brightness of the LED illumination device when the manual operation part 14 is at the positions P1 to PN to brightness of the LED illumination device when the manual operation part 14 is at the first end 141 (P1), respectively. In the example of FIG. 12, the brightness ratio is 0% within a certain range (first range) of which lower limit is BN. Also, the brightness ratio is 100% within a certain range (second range) of which upper limit is B1. The brightness ratio changes monotonically within a range between an upper limit of the first range and a lower limit of the second range.

In Table 2, P1 to PN indicate positions of the manual operation part 14 that are distributed at equal intervals within the operable range (a range between the first end 141 and the second end 142). V11 to V1N indicate values of the first DC voltage V1 when the manual operation part 14 is at the positions P1 to PN, respectively adapted for a case where the illumination load 21 is the incandescent lamp. D21 to D2N indicate conduction angles of the switch 3 when the manual operation part 14 is at the positions P1 to PN (corresponding to the values V11 to V1N of the first DC voltage V1), respectively adapted for a case where the illumination load 21 is the incandescent lamp. B1 to BN indicate ratios of the brightness of the incandescent lamp when the manual operation part 14 is at positions P1 to PN to brightness of the incandescent lamp when the manual operation part 14 is at the first end 141 (P1), respectively. In the example of FIG. 12, the brightness ratio is 0% within a certain range (first range) of which lower limit is BN. Also, the brightness ratio is 100% within a certain range (second range) of which upper limit is B1. The brightness ratio changes monotonically within a range between an upper limit of the first range and a lower limit of the second range.

As indicated by the rightmost columns of Tables 1 and 2, the brightness ratio of the brightness of illumination load 21 at any position in the operable range of the manual operation part 14 to the brightness of the illumination load 21 when the manual operation part 14 is at the first end 141 in the case where the illumination load 21 is the LED illumination device is the same as that in the case where the illumination load 21 is the incandescent lamp.

In the first setting table and the second setting table, the columns of “position of manual operation part 14” and “brightness ratio” are optional, and the first setting table and the second setting table may not include these columns.

In another specific example, the first data table includes a single setting table associating the first DC voltages V1 to be set by the setter 8 with the conduction angles for the LED illumination device and the conduction angles for the incandescent lamp. An example of such a setting table is shown in Table 3.

TABLE 3

| position of | | conduction | conduction | |
|---|---|---|---|---|
| manual | | angle (for LED | angle (for | bright- |
| operation | first DC | illumination | incandescent | ness |
| part 14 | voltage V1 | device) | lamp) | ratio |
| first end (P1) | V11 | D11 | D21 | B1 |
| P2 | V12 | D12 | D22 | B2 |
| P3 | V13 | D13 | D23 | B3 |
| . . . | . . . | . . . | . . . | . . . |
| second end (PN) | V1N | D1N | D2N | BN |

In Table 3, P1 to PN indicate positions of the manual operation part 14 that are distributed at equal intervals within the operable range (a range between the first end 141 to the second end 142). V11 to V1N indicate values of the first DC voltage V1 when the manual operation part 14 is at the positions P1 to PN, respectively. D11 to D1N indicate conduction angles of the switch 3 when the manual operation part 14 is at the positions P1 to PN (corresponding to the respective values V11 to V1N of the first DC voltage V1), respectively adapted for a case where the illumination load 21 is the LED illumination device. D21 to D2N indicate conduction angles of the switch 3 when the manual operation part 14 is at the positions P1 to PN (corresponding to the respective values V11 to V1N of the first DC voltage V1), respectively adapted for a case where the illumination load 21 is the incandescent lamp. B1 to BN indicate ratios of the brightness of the illumination load 21 when the manual operation part 14 is at the positions P1 to PN to brightness of the illumination load 21 when the manual operation part 14 is at the first end 141 (P1), respectively. In the example of FIG. 12, the brightness ratio is 0% within a certain range (first range) of which lower limit is BN. Also, the brightness ratio is 100% within a certain range (second range) of which upper limit is B1. The brightness ratio changes monotonically within a range between an upper limit of the first range and a lower limit of the second range.

In the setting table, the columns of “position of manual operation part 14” and “brightness ratio” are optional, and the setting table may not include these columns.

In an example, the control circuit 5 is configured to determine whether the illumination load 21 is the LED illumination device or the incandescent lamp, based on the second DC voltage within the predetermined time period (the first period T1) from start of supply of the AC voltage to the rectifier 6, where the second DC voltage V2 corresponds to a voltage obtained by full-wave rectification on the AC voltage by the rectifier 6, and, after the predetermined time period has elapsed, determine a timing for turning on the switch 3 (a timing at which the AC voltage of the AC power source 20 is zero) based on the second DC voltage V2.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

1. A dimming device, comprising:
a pair of terminals;
a switch connected between the pair of terminals;
a driver configured to turn on and off the switch;
a control circuit configured to control the driver;
a rectifier connected between the pair of terminals in parallel to the switch and configured to perform full-wave rectification on an AC voltage;
a power supply configured to generate a predetermined DC voltage from a voltage obtained by full-wave rectification on the AC voltage by the rectifier to supply the predetermined DC voltage to the driver and the control circuit; and
a setter configured to set a first DC voltage that corresponds to a conduction angle of the switch,
the control circuit being configured to control the driver to provide reverse phase control based on the AC voltage and to control the driver in accordance with a magnitude of the first DC voltage set by the setter to thereby adjust a value of the conduction angle of the switch,
the control circuit including a determiner configured to, when a series circuit of an illumination load and an AC power source for supplying the AC voltage is connected between the pair of terminals, determine whether the illumination load is an LED illumination device including a capacitor or an incandescent lamp,
the determiner being configured to determine whether the illumination load is the LED illumination device or the incandescent lamp, based on a second DC voltage within a predetermined time period from start of supply of the AC voltage to the rectifier, the second DC voltage corresponding to the voltage obtained by full-wave rectification on the AC voltage by the rectifier, and
the control circuit being configured to control the driver under a condition where values of the conduction angle of the switch corresponding to magnitudes of the first DC voltages except a maximum and a minimum thereof in a case where the determiner determines that the illumination load is the LED illumination device are smaller than values of the conduction angles of the switch of a case where the determiner determines that the illumination load is the incandescent lamp.

2. The dimming device of claim 1, wherein
the determiner is configured to:
when an average of the second DC voltage within the predetermined time period is equal to or more than a predefined threshold, determine that the illumination load is the incandescent lamp; and
when the average is less than the threshold, determine that the illumination load is the LED illumination device.

3. The dimming device of claim 1, wherein
the determiner is configured to determine whether the illumination load is the LED illumination device or the incandescent lamp based on a waveform of the second DC voltage within the predetermined time period.

4. The dimming device of claim 1, wherein
the control circuit is configured to:
in a case where the determiner determines that the illumination load is the incandescent lamp, control the driver so as to increase the conduction angle of the switch at a constant rate with an increase in the first DC voltage; and
in a case where the determiner determines that the illumination load is the LED illumination device, control the driver so as to increase the conduction angle of the switch at a gradually increasing rate with an increase in the first DC voltage.

5. The dimming device of claim 1, wherein
the control circuit is configured to:
in a case where the determiner determines that the illumination load is the LED illumination device, determine a first ON time for the LED illumination device in accordance with a value of the first DC voltage, and control the switch in a manner where the control circuit turns on the switch when an absolute value of the AC voltage becomes equal to or smaller than a predetermined threshold value and turns off the switch when the first ON time elapses after the control circuit turns on the switch; and
in a case where the determiner determines that the illumination load is the incandescent lamp, determine a second ON time for the incandescent lamp in accordance with a value of the first DC voltage, and control the switch in a manner where the control circuit turns on the switch when the absolute value of the AC voltage becomes equal to or smaller than a predetermined threshold value and turns off the switch when the second ON time elapses after the control circuit turns on the switch.

6. The dimming device of claim 1, wherein:
the rectifier includes a diode bridge;
the power supply includes a constant voltage element and an electrolytic capacitor;
the setter includes a variable resistor;
the diode bridge includes a pair of input terminals respectively connected to the pair of terminals;
the diode bridge includes a positive output terminal connected to a positive electrode side input terminal of the constant voltage element, and a negative output terminal connected to a negative electrode side input terminal of the constant voltage element;
the constant voltage element includes a positive electrode side output terminal connected to a positive electrode of the electrolytic capacitor 72, and a negative electrode side output terminal connected to a negative electrode of the electrolytic capacitor; and
the variable resistor is connected between the positive electrode and the negative electrode of the electrolytic capacitor.
